(19) United States
(12) Patent Application Publication
(10) Pub. No.: US 2008/0313067 A1
(43) Pub. Date: Dec. 18, 2008

(54) MANAGEMENT AND DECISION MAKING TOOL FOR COMMODITY PURCHASES WITH HEDGING SCENARIOS

(75) Inventors: Robert M. Fell, Summerland, CA (US); Scott Painter, Bel Air, CA (US); Michael R. Bonsignore, Seattle, WA (US); Brian P. Reed, Southlake, TX (US); Gary A. Magnuson, Corpus Christi, TX (US)

Correspondence Address: SPRINKLE IP LAW GROUP, 1301 W. 25TH STREET, SUITE 408, AUSTIN, TX, 78705, US

(73) Assignee: Pricelock, Inc., Irving, TX (US)

(21) Appl. No.: 12/029,961

(22) Filed: Feb. 12, 2008

Related U.S. Application Data
(60) Provisional application No. 60/900,928, filed on Feb. 12, 2007.

(51) Int. Cl. G06Q 40/00

(52) U.S. Cl. 705/35

(57) ABSTRACT

Methods for managing hedging scenarios associated with a retail commodity. The method includes enabling the creation of a risk profile associated with a user and the commodity. Based on the risk profile, the method includes selecting hedging scenario(s) associated with purchasing a quantity of the commodity. The method also includes determining a user cost associated with purchasing the hedging scenarios using a time-based price of the commodity and outputting the costs. In some embodiments the time-based price is historic. The method can include enabling the user to purchase a hedging scenarios. Some embodiments include accepting a commodity consumption pattern, adjustments to the pattern, what-if cases, costs to the provider of the hedging scenarios. The costs (and savings) to the user can be determined based on the accepted consumption patterns (and adjustments) what-if cases, and provider costs. Systems and programs for managing such hedging scenarios also provided.

### CROSS-REFERENCE TO RELATED APPLICATIONS

This application claims priority from Provisional Patent Application No. 60/900,928 entitled “MANAGEMENT AND DECISION MAKING TOOL FOR COMMODITY PURCHASES WITH HEDGING SCENARIOS,” filed Feb. 12, 2007, by Fell et al., which is incorporated herein as if set forth in full.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

Embodiments of the disclosure relate generally to computer-implemented management and decision making tools. More particularly, this application relates to a system and method implementing management and decision making tools for retail commodity purchases under various hedging scenarios.

### BACKGROUND

Making a decision to purchase a retail commodity can be a very difficult process, particularly if a large quantity or volume of the commodity is to be purchased but that commodity tends to fluctuate in an unpredictable manner. For example, as the price of oil continues to fluctuate globally and fluidly, fuel prices at the pump can change from location to location on a daily or even hourly basis. In such a volatile market, it is extremely difficult for fleet managers and consumers alike to make sound decisions on where, how much, when, or even what fuel grade to buy and the terms on which to buy the commodity.

### SUMMARY

One object of the disclosure is to provide a new way to facilitate the decision making process of retail commodity purchases. This object can be achieved in a computer-implemented management and decision making tool that can be adaptive, interactive, and easy-to-use. More specifically, embodiments of the management and decision making tool (MDMT) disclosed herein can be implemented with a plurality of functions that offer additional analytics to support the purchase decision, by a consumer, a fleet manager, a financial manager, or anyone who is authorized to purchase the retail commodity for commercial or other purposes.

In one embodiment, the MDMT uses estimated forward retail gasoline prices, along with historical or predicted consumption of fuels, to determine estimated fuel costs for an upcoming period. The fuel costs thus estimated can be compared with fuel costs estimated under various hedging strategies or scenarios. The MDMT estimates the savings that could be realized by implementing a “Pricelock” on a hedging strategy and presenting the results to a user or users via a user interface (in some embodiments the user interface can be a Web browser application running on the user's computer). Each time the user selects a different hedging strategy, the potential savings can be dynamically changed to reflect the selection. The MDMT can be used to drive both initial and additional purchases.

The management and decision making tool disclosed herein can be configured to implement a comprehensive solution (also referred to as the Pricelock system) for price protection on retail commodities. Embodiments of the Pricelock system can be found in U.S. patent application Ser. No. 11/705,571, filed on Feb. 12, 2007, by Fell et al., entitled “METHOD AND SYSTEM FOR PROVIDING PRICE PROTECTION FOR COMMODITY PURCHASING THROUGH PRICE PROTECTION CONTRACTS,” which is incorporated herein as if set forth in full.

Various embodiments provide a number of advantages. Some embodiments allow a consumer to select from a number of standard hedging scenarios and to see the savings such choices might cause in the future (or would have caused in the past). In some embodiments, the savings may be based on estimates of, or actual, commodity consumption patterns. These patterns may be adjusted by the user, in some embodiments, for changes in the consumer's expected consumption patterns. Some embodiments allow what-if cases to be studied in view of the hedging scenarios. Such what-if scenarios can “shock test” the purchasing decision with hypothetical exogenous events. Comparison shopping of the various hedging scenarios is enabled by some embodiments. Various embodiments enable more informed commodity decision purchases and eliminate, or at least reduce, uncertainty from commodity purchase decisions. Some embodiments enable the development of a risk profile associated with the commodity and adjust the displayed hedging scenarios based upon the risk profile. Embodiments can also be adaptive, interactive, and easy to use. Various embodiments save the consumer and the price protection service provider time, effort, and expense in reaching an agreement regarding which hedging scenario to execute.

Other objects and advantages of the present disclosure will become apparent to one skilled in the art upon reading and understanding the detailed description of the embodiments described herein.

### BRIEF DESCRIPTION OF THE DRAWINGS

A more complete understanding of the disclosure and the advantages thereof may be acquired by referring to the following description, taken in conjunction with the accompanying drawings in which like reference numbers generally indicate like features and wherein:

FIG. 1 illustrates one embodiment of a method of calculating and displaying estimated future commodity costs.

FIG. 2 illustrates one embodiment of a method of calculating and displaying estimated hedged commodity costs.

FIG. 3 illustrates one embodiment of a system for managing hedging scenarios associated with a retail commodity and making decisions pertaining thereto.

FIG. 4 illustrates a screenshot of a one embodiment of graphical user interface for managing hedging scenarios associated with a retail commodity and making decisions pertaining thereto.

FIG. 5 illustrates another screenshot of a one embodiment of graphical user interface for managing hedging scenarios associated with a retail commodity and making decisions pertaining thereto.

FIG. 6 illustrates another screenshot of a one embodiment of graphical user interface for managing hedging scenarios associated with a retail commodity and making decisions pertaining thereto.

FIG. 7 illustrates yet another screenshot of a one embodiment of graphical user interface for managing hedging scenarios associated with a retail commodity and making decisions pertaining thereto.

FIG. 8 illustrates another screenshot of a one embodiment of graphical user interface for managing hedging scenarios associated with a retail commodity and making decisions pertaining thereto.

### DETAILED DESCRIPTION

The disclosure and the various features and advantageous details thereof are explained more fully with reference to the non-limiting embodiments that are illustrated in the accompanying drawings and detailed in the following description. Descriptions of well known starting materials, processing techniques, components and equipment are omitted so as not to unnecessarily obscure the disclosure in detail. Skilled artisans should understand, however, that the detailed description and the specific examples, while disclosing preferred embodiments, are given by way of illustration only and not by way of limitation. Various substitutions, modifications, additions or rearrangements within the scope of the underlying inventive concept(s) will become apparent to those skilled in the art after reading this disclosure.

Before discussing specific embodiments, an embodiment of a hardware architecture for implementing certain embodiments is described herein. One embodiment can include a computer communicatively coupled to a network (the Internet in some embodiments). As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylist, etc.), or the like. In various embodiments, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

The functionalities and processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. In some embodiments, a process, process, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. In some embodiments, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example”, “for instance”, “e.g.”, “in one embodiment”.

Within this disclosure, the term “commodity” refers to an article of commerce—an item that can be bought and sold freely on a market. It may be a product which trades on a commodity exchange or spot market and which may fall into one of several categories, including energy, food, grains, and metals. Currently, commodities that can be traded on a commodity exchange include, but are not limited to, crude oil, light crude oil, natural gas, heating oil, gasoline, propane, ethanol, electricity, uranium, lean hogs, pork bellies, live cattle, feeder cattle, wheat, corn, soybeans, oats, rice, cocoa, coffee, cotton, sugar, gold, silver, platinum, copper, lead, zinc, tin, aluminum, titanium, nickel, steel, rubber, wool, polypropylene, and so on. Note that a commodity can refer to tangible things as well as more ephemeral products. Foreign currencies and financial indexes are examples of the latter. For example, positions in the Goldman Sachs Commodity Index (GSCI) and the Reuters Jefferies Consumer Research Board Index (RJCRB Index) can be traded as a commodity. What matters is that something be exchanged for the thing. New York Mercantile Exchange (NYMEX) and Chicago Mercantile Exchange (CME) are examples of a commodity exchange. Other commodities exchanges also exist and are known to those skilled in the art.

In a simplified sense, commodities are goods or products with relative homogeneousness that have value and that are produced in large quantities by many different producers; the goods or products from each different producer are considered equivalent. Commoditization occurs as a goods or products market loses differentiation across its supply base. As such, items that used to carry premium margins for market participants have become commodities, of which crude oil is an example. However, a commodity generally has a definable quality or meets a standard so that all parties trading in the market will know what is being traded. In the case of crude oil, each of the hundreds of grades of fuel oil may be defined. For example, West Texas Intermediate (WTI), North Sea Brent Crude, etc. refer to grades of crude oil that meet selected standards such as sulfur content, specific gravity, etc., so that all parties involved in trading crude oil know the qualities of the crude oil being traded. Motor fuels such as gasoline represent examples of energy-related commodities that may meet standardized definitions. Thus, gasoline with an octane grade of 87 may be a commodity and gasoline with an octane grade of 93 may also be a commodity, and they may demand different prices because the two are not identical—even though they may be related. Those skilled in the art will appreciate that other commodities may have other ways to define a quality. Other energy-related commodities that may have a definable quality or that meet a standard include, but are not limited to, diesel fuel, heating oils, aviation fuel, and emission credits. Diesel fuels may generally be classified according to seven grades based in part on sulfur content, emission credits may be classified based on sulfur or carbon content, etc.

Historically, risk is the reason exchange trading of commodities began. For example, because a farmer does not know what the selling price will be for his crop, he risks the margin between the cost of producing the crop and the price he achieves in the market. In some cases, investors can buy or sell commodities in bulk through futures contracts. The price of a commodity is subject to supply and demand.

A commodity may refer to a retail commodity that can be purchased by a consuming public and not necessarily the wholesale market only. One skilled in the art will recognize that embodiments disclosed herein may provide means and mechanisms through which commodities that currently can only be traded on the wholesale level may be made available to retail level for retail consumption by the public. One way to achieve this is to bring technologies that were once the private reserves of the major trading houses and global energy firms down to the consumer level and provide tools that are applicable and useful to the retail consumer so they can mitigate and/or manage their measurable risks involved in buying/selling their commodities. One example of an energy related retail commodity is motor fuels, which may include various grades of gasoline. For example, motor fuels may include 87 octane grade gasoline, 93 octane grade gasoline, etc as well as various grades of diesel fuels. Other examples of an energy related retail commodity could be jet fuel, heating oils, electricity or emission credits such as carbon offsets. Other retail commodities are possible and/or anticipated.

While a retail commodity and a wholesale commodity may refer to the same underlying good, they are associated with risks that can be measured and handled differently. One reason is that, while wholesale commodities generally involve sales of large quantities, retail commodities may involve much smaller transaction volumes and relate much more closely to how and where a good is consumed. The risks associated with a retail commodity therefore may be affected by local supply and demand and perhaps different factors. Within the context of this disclosure, there is a definable relationship between a retail commodity and the exposure of risks to the consumer. This retail level of the exposure of risks may correlate to the size and the specificity of the transaction in which the retail commodity is traded. Other factors may include the granularity of the geographic market where the transaction takes place, and so on. For example, the demand for heating oil No. 2 in January may be significantly different in the Boston market than in the Miami market.

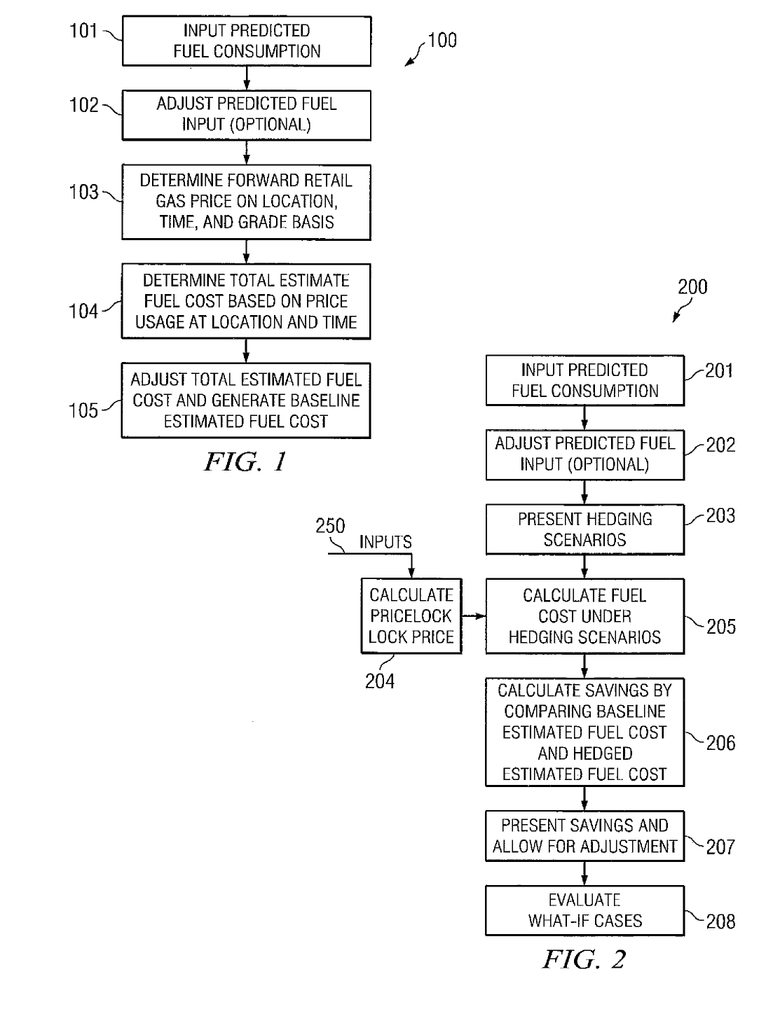

FIG. 1 is a flow diagram representing a simplified process 100 of calculating and graphically displaying estimated forward retail fuel costs, according to one embodiment. At step 101, a user (a manager in some embodiments) inputs predicted fuel consumption in gallons by fuel type and location. This step can be implemented to allow as much granularity as possible. Step 101 can be configured to provide granularity per location, quantity, fuel type or grade, and time period.

As to the location, the user may be allowed to input by retail station, zip code, MSA, county, state, country, etc. Input data then can be aggregated to the county level for pricing against NYMEX data. In some embodiments, if a user inputs fuel consumption in a number of locales, those zip codes can be rolled into their appropriate counties and the gallon consumption is compiled accordingly.

As to quantity, the user may be allowed to enter the number of gallons per locale, per time period. The time period may be months, weeks, days, or any other duration.

As to grade, the user may be allowed to enter the specific fuel type and/or grade (unleaded or diesel in some embodiments). In some embodiments, the fuel can be 87 octane unleaded gasoline.

As to time period, the user may enter the time month by month or other time period as may be desired. In some embodiments, the time period may coincide with the time periods associated with an exchange's forward contract pricing.

Step 101 can be implemented to use user inputs as estimates or obtain historical consumption data from historical feeds. In some embodiments, such data may originate at one or more transactional data aggregators such as Wright Express, WEX, or other fuel or credit card provider, fleet or logistics systems, or the like. A database can be being configured to automatically be populated with the historical consumption data.

Step 102 can be optionally implemented to provide the user the ability to adjust the predicted fuel inputs to account for anticipated or potential variance from historical consumption patterns, particularly in the case where historical consumption data is used to populate the database as forward consumption patterns might differ from the historical data or estimate. Step 102 can be executed manually by the user or through a wizard program implementing the Pricelock “interview” process. The wizard program, which in one embodiment is implemented as a software module of the MDMT, can operate to analyze the existing data, ask the user which components of the predicted fuel consumption need to be modified (in some embodiments, these components can include specific location consumption changes, an overall volume increase of 10%, a new location, etc.), and display or highlight those fields requiring modification(s).

Step 103 can be implemented to calculate estimated forward gasoline prices on a location, time, and grade basis and present them graphically over time. Embodiments which estimate forward gasoline prices are found in U.S. patent application Ser. No. 11/705,571, filed on Feb. 12, 2007, by Fell et al., entitled “METHOD AND SYSTEM FOR PROVIDING PRICE PROTECTION FOR COMMODITY PURCHASING THROUGH PRICE PROTECTION CONTRACTS,” which is incorporated herein as if set forth in full. Step 103 can be implemented to provide the user with the ability to selectively change the estimated forward gasoline prices and manually override certain estimated forward retail prices by desired locations and time periods. Step 103 can also be implemented to provide the user with the ability to import, or otherwise input, forward gasoline price estimates from other sources. In some embodiments, if a fleet card provider offers estimates for future fuel prices, these estimates could be displayed to the user and used in the corresponding analysis.

Step 104 can be implemented to calculate the total estimated fuel cost based on user inputs from steps 101 and 102 such as price, usage at the location(s) over specific time periods, utilizing output data that can be graphically represented in step 103 to sum the total retail gasoline prices in numeric form, based on locations, volume, and specified time.

Step 105 can be implemented to allow the user to adjust the total estimated fuel costs, take into consideration user selected event(s), and utilize underlying data obtained/generated so far. This can allow the user to add sensitivities to the total estimated fuel costs. Embodiments implementing sensitivity analysis are described in U.S. patent application Ser. No. 11/705,571, filed on Feb. 12, 2007, by Fell et al., entitled “METHOD AND SYSTEM FOR PROVIDING PRICE PROTECTION FOR COMMODITY PURCHASING THROUGH PRICE PROTECTION CONTRACTS,” which is incorporated herein as if set forth in full.

FIG. 2 is a flow diagram representing process 200 of calculating and graphically displaying estimated forward retail fuel costs with various hedging scenarios, according to some embodiments. Steps 201 and 202 can be essentially the same as steps 101 and 102 described above.

At step 203, based on the estimated fuel consumption data from step 201 or 202, available hedge positions and associated Pricelock pricing can be presented to the user. Step 203 can be implemented in many ways. In some embodiments, available hedge positions and associated Pricelock pricing can be presented as hedging scenarios or risk profiles. In some embodiments a risk profile may be built for the user. In some embodiments, a set of pre-defined options may be presented to the user.

In some embodiments, the user may select a “risk profile” or a hedge position corresponding to a desired coverage. After the selection is made, the user (a fleet manager in some embodiments) can be taken through a series of questions relating to various considerations such as 1) risk tolerance; 2) available cash resources; 3) interest in financing prepayment of fuel; 4) willingness to ‘push’ drivers to affinity and/or preferred stations, etc.

Additionally, step 203 can be implemented to consider product definition variables including, but not limited to, the amount of total gasoline purchases to “lock”, the percentage of gasoline desired to be purchased at affinity and/or preferred stations, a tolerance above the “lock” price that would deplete a virtual reserve tank (which may be referred to as the Pricelock Gasoline Tank in some embodiments). The Pricelock Gasoline Tank may be representative of the amount of fuel, in gallons and dollars, that can be pre-purchased and locked in at a certain price per gallon.

Independent of steps 201, 202, and 203 (i.e., pre-user input), step 204 can be implemented to calculate matrices of available lock prices and insurance/hedge costs per gallon. Due to constantly changing gasoline prices, consumption patterns, and forward contract prices, these matrices may be priced dynamically and continuously.

According to one embodiment, inputs 250 can be a multi-dimensional matrix of strike prices for all available locations (the approximately 4000 counties in the United States in some embodiments) for that day, provided by a hedging partner, along with the hedge cost per gallon (HCPG) charged by the hedging partner. The HCPG is the lock insurance cost according to one embodiment. Based on inputs 250, step 204 may operate to generate Pricelock matrices, which may include fuel type, locations, lock insurance costs, lock strike prices, Pricelock markup, affinity/preferred discount percentage and term (duration). Step 204 can be implemented to provide a separate multi-dimensional analysis table for each fuel/time. In one embodiment, step 204 can be implemented to display Pricelock lock prices by product type (including a preference to purchase from affinity retailers along with a preference to lock at a 10% tolerance above lock price in some embodiments) and optionally in price per gallon. In one embodiment, step 204 can be implemented to graphically display, via a national map, a Pricelock Lock Price matrix (location, grade, time) for lock prices and insurance/hedge costs.

Step 205 can be implemented to apply Pricelock matrices (step 204) to the predicted fuel consumption (step 201 or 202) to calculate the estimated fuel cost under different hedging scenarios (chosen by the user at step 203). In some embodiments, if the user chooses to “pricelock” in unleaded gasoline over a 3-month period, with a lock price of $3.20, a purchase tolerance of $0.05 (meaning that the Pricelock Gasoline Tank may only be depleted when the price of retail gasoline is $3.25 in some embodiments) and does not wish to participate in affinity discounts, the Pricelock matrix for unleaded gasoline may have a “lock price” calculated for this product mix (which can reflect a composite of the various components described above with reference to step 204) for each county. This “lock price” by county can be multiplied by the number of gallons by county (entered by the user in step 201) to calculate a total pre-purchase amount.

Step 206 can be implemented to calculate the savings by comparing the estimated fuel costs with and without hedging. More specifically, the estimated fuel cost generated in step 105 of process 100 (which can be used as a baseline cost) may be compared with the estimated hedged cost generated in step 205 of process 200.

Step 207 can be implemented to represent both the baseline and the hedged estimated fuel costs graphically or numerically. Step 207 can be implemented to dynamically change the graphical representation of costs/savings to reflect hedging choices the user makes. In some embodiments, if the user (a fleet manager in some embodiments) chooses to “lock in” only 50% of the fleet's anticipated fuel consumption over a prescribed period, the savings can be dynamically and correspondingly calculated and represented to facilitate the user to compare costs and make informed decisions.

Additionally, step 207 can be implemented to allow the user to adjust the savings based on external factors such as cost of funds (internal hurdle rates in some embodiments) and interest rates. This can be a useful feature in cases where a user chooses to utilize a financing partner to facilitate the pre-purchase of fuels. Step 208, in some embodiments, can be implemented to adjust the estimated savings based on various what-if cases. These what-if cases can include, in some embodiments, hurricanes, wars, political changes, supply disruptions, interest rate changes, and various world events.

As one skilled in the art can appreciate, embodiments disclosed herein can be implemented and/or augmented in many ways. In some embodiments, the management and decision tool can be further implemented to provide a theoretical historical savings analysis based on actual transactional data on fuel consumption and historical data on Pricelock lock prices. The results of this theoretical analysis can show a customer (in some embodiments, the customer can be a commercial fleet, a business, a governmental agency, etc.) how much savings “would have” been realized if they “would have” purchased fuel over some historical period of time.

Theoretical historical savings analysis (comparing retail commodity purchases with hedged purchases in some embodiments) may consider the following consumer inputs: a) consumer consumption patterns by fuel grade, location and time period; b) Pricelock and/or other sources of transactional data of actual historical retail prices; and c) actual transactional data from one or more fuel card providers (which, in some embodiments, can be WEX, Voyager, etc.) if the consumer is an existing fuel card customer.

The theoretical historical savings analysis may operate to combine inputs a, b and c in various ways to estimate commodity costs, by month, by fuel grade without utilizing the Pricelock functionality as described above. Moreover, the consumer can have the ability to modify inputs a, b, and c, and estimated costs if desired.

For the estimate of the hedged position, the theoretical historical savings analysis may (based on the product choices defined by the consumer in step 205 in some embodiments), access the Pricelock pricing matrices from the beginning of a historical period defined by the consumer. The theoretical historical savings analysis can then provide a historical comparison between fuel costs estimated based on the consumer inputs and the Pricelock lock prices over the historical period of time or over some period of interest.

The above-described analyses could be applied to historical consumption and historical market data, and using a matrix of historical strike prices and HCPG, and a backward looking “historical” pricing model, an analysis can be performed that shows a consumer what the savings “could have been” if they had purchased a fuel hedge. Similarly, if the customer is using Pricelock hedging and actual consumption is known, the benefit can be calculated in a similar manner.

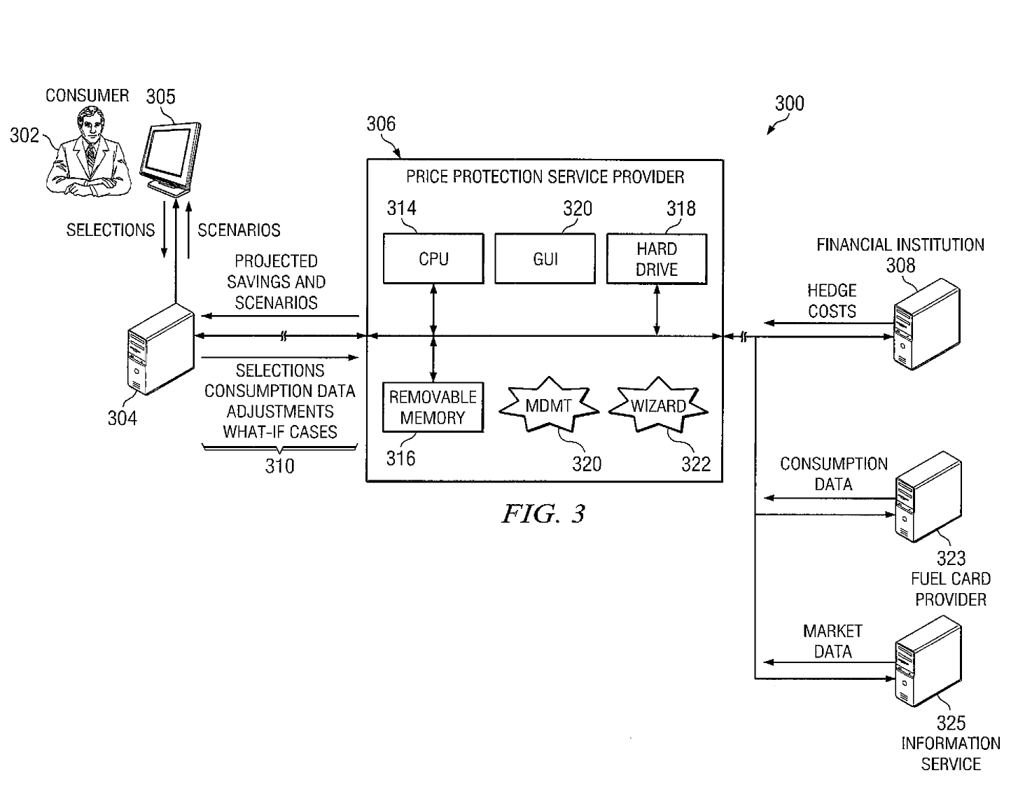

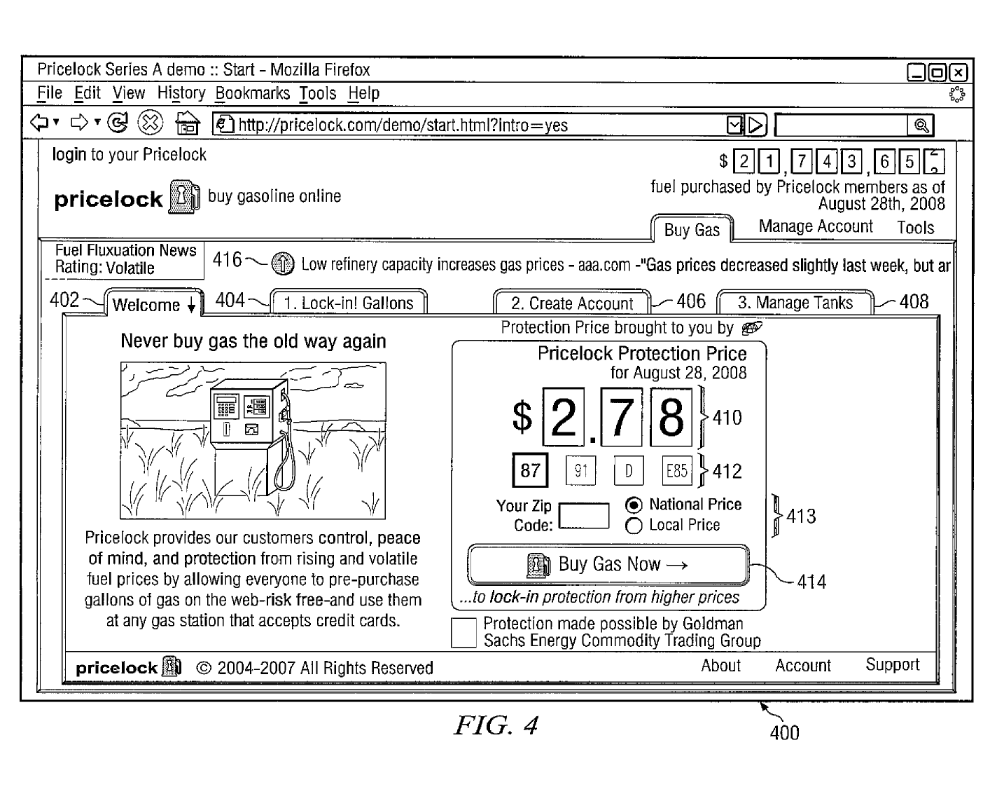

FIG. 3 illustrates price protection system 300 which consumer 302 can use to manage hedging scenarios and make decisions associated with purchasing a retail commodity. In some embodiments, system 300 includes consumer computer 304, price protection service provider server 306, financial institution computer 308, and network 310. Consumer computer 304 can include user input/output devices such as display 305 and can be any time of device capable of presenting graphical user interfaces (GUIs) (to be discussed more with reference to FIGS. 4-9) to user 302 such as a PC, a laptop, a personal digital assistant, a mobile phone, etc. Server 306 can be any type of device capable of serving GUIs to consumer computer 304 and receiving matrices of available lock prices and insurance/hedge costs. Computer 308 can be any type of device capable of sending the matrices of available lock prices and insurance/hedge costs to price protection service provider 306. In various embodiments, computer 306 can be part of the Pricelock system and can include CPU 314, removable media device 316, hard drive 318 or other type of long term memory, and can host MDMT including GUI 320 and interview wizard 322.

Network 310 can serve to allow the computers 304, 306, and 308 to communicate with each other. In various embodiments, user 302 can use system 300 to obtain information about available price protection services. The consumer can use a client, web browser, etc. executing on consumer computer 304 to request from price protection service server 306 a GUI 320 which can contain the information about available price protection services. Server 306 can respond by sending consumer computer 304 requested GUI 320 via network 310 which can be the Internet, a WAN, a LAN, a wireless network, etc. Consumer computer 304 can display GUI 320 on display 305 and enable user 302 to navigate through the various pages, screens, etc. of GUI 320. User 302 may also use GUI 320 via system 300 to select price protection services as disclosed herein. In some embodiments, system 300 includes fuel card provider 323 which can supply historic consumption data relevant to user 302. System 300 can include information service provider 325 which can provide data regarding the commodity market. In some embodiments information service provider 325 can be Reuters or Bloom berg although many other information service providers are available and within the scope of the disclosure

Embodiments of price protection service system 300 are described in U.S. patent application Ser. No. 11/705,571, filed Feb. 12, 2007, by Fell et al., entitled “METHOD AND SYSTEM FOR PROVIDING PRICE PROTECTION FOR COMMODITY PURCHASING THROUGH PRICE PROTECTION CONTRACTS,” which is incorporated herein as if set forth in full.

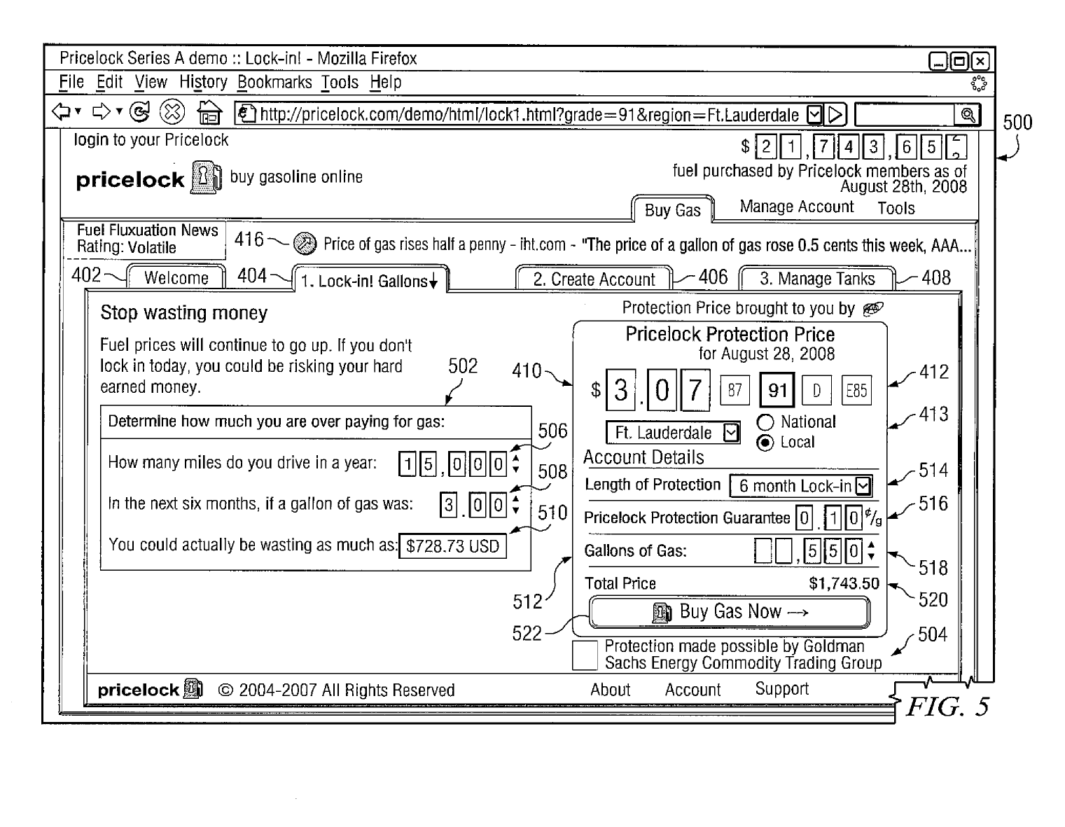

With reference now to FIG. 4, screenshot 400 of one embodiment of GUI 320 is illustrated. Screenshot 400 can represent a screen from which user 302 can navigate to various features of the GUI. Screenshot 400 shows welcome tab 402, lock-in tab 404, account creation tab 406, and account management tab 408. Lock-in tab 402 can include a display 410 of the current lock price for 87 octane grade of a retail commodity which can be selected by user 302 using elements 412. In this example the retail commodity is unleaded gasoline. User 302 can select between a local or national current lock price 410 with selection elements 413. Lock-in tab 402 can also include a button or other element 414 to allow a consumer to navigate to a screen represented by screenshot 500 (of FIG. 5) on which user 302 can begin to purchase a price protection service. In some embodiments, lock-in tab 402 (or other tabs or screens) can include a news display area 416 wherein news relevant to the commodity can be displayed.

Regarding tab 404, lock-in tab 404 can allow user 302 to navigate to screen 500. FIG. 5 shows screenshot 500 of one embodiment of GUI 320. Screenshot 500 can correspond to account creation tab 404 and can include different areas 502 and 504. In areas 502 and 504, respectively, a consumer can determine possible savings associated with purchasing a price protection service and define a price protection service to purchase. Possible savings area 502 can include input elements 506 and 508 and results display 510. In elements 506 and 508 user 302 can input how many miles they drive in a year (or some number of miles which they desire to input) and a price for a gallon of gasoline which they desire to enter respectively. In some embodiments, this price may be a price which user 302 believes will prevail during the period of interest to the user. GUI 320 can be configured in various embodiments to calculate the fuel cost associated with inputs 506 and 508, compare it to the price user 302 would pay in accordance with various price protection services, and display resulting savings in display 510.

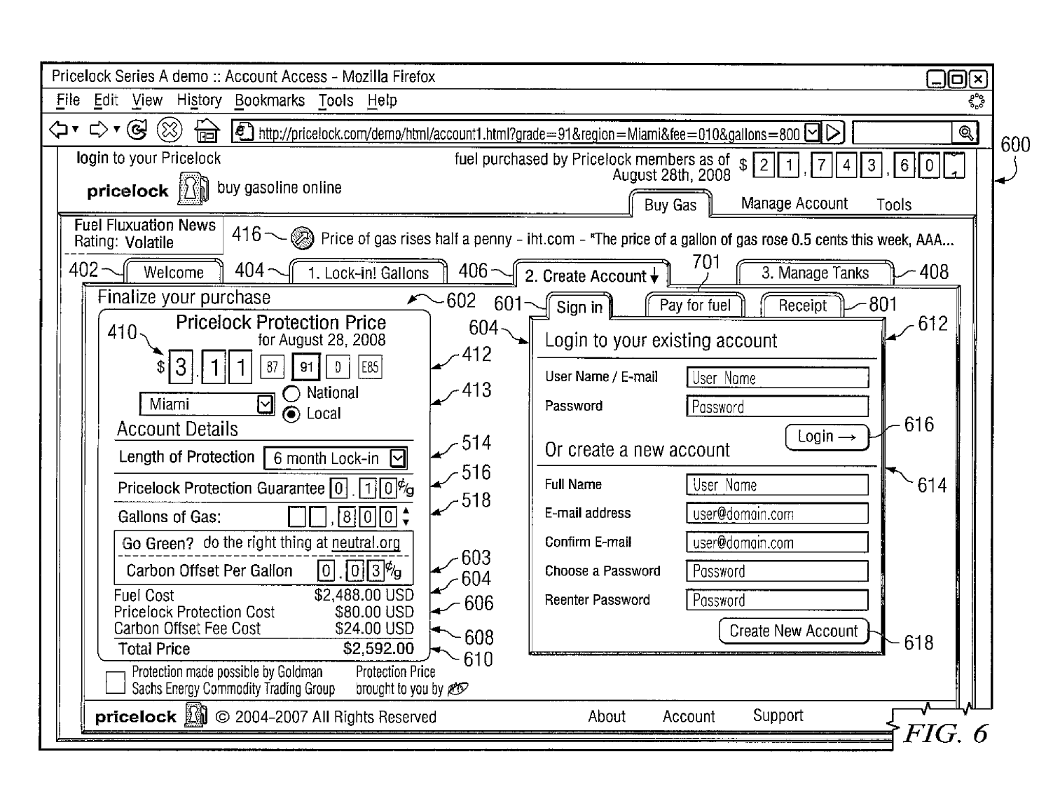

Price protection service definition area 504 of FIG. 5 can display the current lock price 410 (adjusted for national or local results with elements 413 in some embodiments) and sub-area 512 in which user 302 can define the price protection service which they desire. Service definition sub-area 512 can include input element 514, display elements 516, input element 518, display element 520, and button 522. Input 514 can allow user 302 to select, or input, the length of the service plan they desire. Display 516 may display a price (to user 302 in some embodiments) associated with obtaining the price protection service. In some embodiments, the price in display 516 can be on a price-per-gallon basis. Input element 518 can allow user 302 to input a desired quantity of the commodity which they desire to purchase via the price protection service. GUI 320 can be configured to use the information as displayed by elements 413, 514, 516, and 518 in service definition area 504 to compute a cost for obtaining the price protection service defined by the information in area 504 and display it in result display element 520. Button 522, in some embodiments, may allow user 302 to navigate to a screen represented by screenshot 600 (of FIG. 6) with which the service may be purchased.

FIG. 6 illustrates screenshot 600 of one embodiment of GUI 320 for price protection system 300 (of FIG. 3). Screenshot 600 can correspond to account creation tab 406 and can include two areas 602 and 604. Purchase finalization area 602 can reflect information (in some embodiments, current lock price 410, local/national selection 413, length of protection 514, service price 516, and commodity amount 518) displayed or entered on tabs 400 and 500. In some embodiments such information may be modified on tab 600. Purchase finalization area 602 can include elements such as element 603 which can allow users to select various options associated with the purchase. In some embodiments, element 603 can relate to a carbon offset which can be associated with purchasing amount 518 of the commodity Many other options are available and can be represented on screen 600. GUI 320 can be configured to use information from tabs 402, 404, and 406 to calculate fuel costs, price protection service costs, carbon offset fee costs, and total costs 610 for the price protection service(s) defined by user 302 and display these totals in displays 604, 606, 608, and 610. As shown by FIG. 6, area 604 can include tabs 601, 701, and 801. In some embodiments, tab 601 can include area 612 for a consumer with an existing account on system 300 to log in. FIG. 6 shows that tab 601 can include area 614 for a consumer (who may happen to be new to the system 300) to create an account.

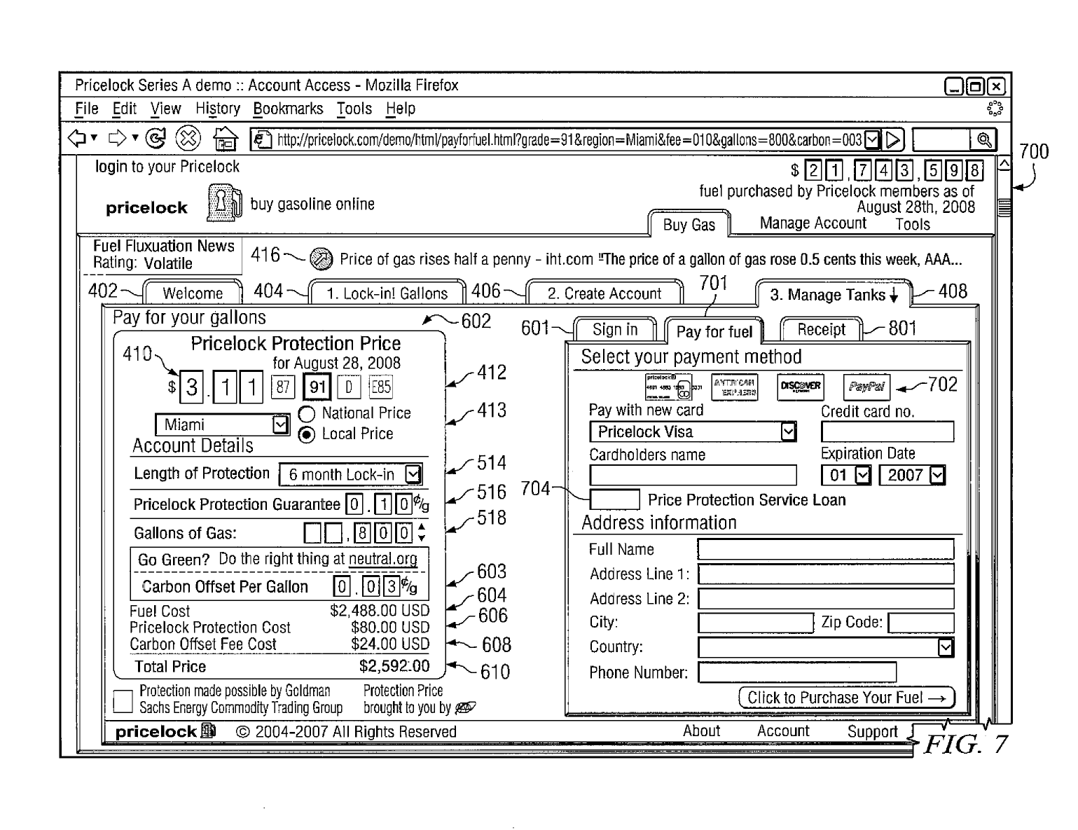

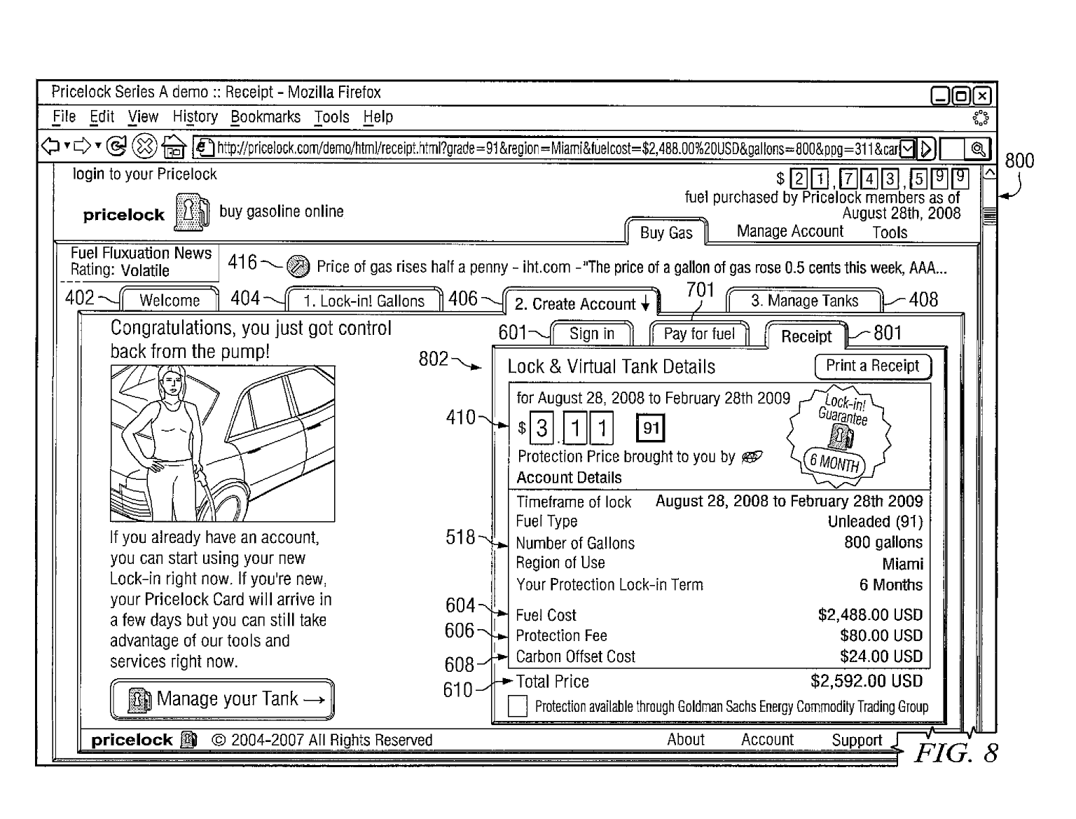

In various embodiments, selection of tab 701 may allow a consumer to navigate to a portion of GUI 320 with which user 302 can pay for the selected price protection service. In various embodiments clicking on either buttons 616 or 618 of FIG. 6 (to login or create an account) may also allow the user to navigate to tab 701. Tab 701, as depicted by FIG. 7, can include elements allowing a user to pay for their purchase using a credit card, electronic funds transfers, etc. In some embodiments, tab 701 can include an element 704 which can enable a consumer to obtain a loan to pay the full, or a portion of, the up-front cost 610 of the service. Examples of payment options are disclosed in U.S. patent application Ser. No. ______ (Attorney Docket No. PRICE1170-1), entitled “SYSTEM AND METHOD FOR ENABLING HEDGING CUSTOMERS TO LOCK FORWARD POSITIONS WITH CUSTOMER-FRIENDLY PAYMENT OPTIONS,” by Fell et al, filed February ______, 2008, which is incorporated herein as if set forth in full. In this manner, user 302 can choose not to expend any funds up-front. Button 706 can be included in tab 701 to enable user 302 to submit the terms of the service (defined as described herein) and the terms of payment to system 300 of FIG. 3 for acceptance by system 300. System 300 (of FIG. 3) can verify the financing information from tab 701 and confirm that the requested price protection service is available, and return receipt 800 (of which an embodiment is shown in FIG. 8) to user 302 via GUI 320.

In some embodiments, GUI 320 can present more than one type of hedging scenario to user 302. Such hedging scenarios can include: purchasing the commodity at a retail price; purchasing the commodity at current lock price 410, purchasing the commodity at lock price 410 plus a mark-up, purchasing the commodity at lock price 410 minus a mark-down, purchasing the commodity within a symmetric price collar about lock price 410, or purchasing the commodity within an asymmetric collar about lock price 410. In some embodiments, a collar can be a financial structure including a put and a call associated with the commodity. When the collar is symmetric, the put and the call can be equidistant from the at-the-money point. When the collar is asymmetric, the put and the call can be different distances from the at-the-money point.

For each hedging scenario, GUI 320 can display the projected resulting savings based on a comparison between the forward retail price(s) and purchasing according to the corresponding hedging scenario. System 300 can be configured to calculate these projected resulting savings. GUI 320 can include input elements (or displays as the case may be) for information related to the hedging scenarios. Such information can include, but is not limited to: price protection service period, retail price of the retail commodity, a locale, the current retail price, current lock price 410, a desired mark-up, a desired mark-down, an upper collar limit, and a lower collar limit. In some embodiments, GUI 320 can also include a series of buttons corresponding to the displayed hedging scenarios. GUI 320 can be configured such that clicking on one of buttons indicates that user 302 has selected the corresponding hedging scenario for purchase. GUI 320 can navigate user 302 to a portion of GUI 320 similar to that illustrated in FIG. 7 (with the appropriate items of information filled in automatically in some embodiments) so that user 302 can review and purchase the selection if desired.

Although embodiments have been described in detail herein, it should be understood that the description is by way of example only and is not to be construed in a limiting sense. It is to be further understood, therefore, that numerous changes in the details of the embodiments and additional embodiments will be apparent, and may be made by, persons of ordinary skill in the art having reference to this description. It is contemplated that all such changes and additional embodiments are within scope of the following claims and their legal equivalents.

What is claimed is:

1. A computer-readable storage medium carrying program instructions executable by a processor to:
create a risk profile associated with a customer, a commodity, or a combination thereof;
based on the risk profile, create one or more hedging scenarios associated with a purchase of a quantity of the commodity;
determine a cost associated with each of the one or more hedging scenarios using a time-based price associated with the commodity; and
present the one or more hedging scenarios to the customer, wherein the customer is an individual user or an entity.

2. The computer-readable storage medium of claim 1, wherein the time-based price is a historic time-based price.

3. The computer-readable storage medium of claim 1, wherein the program instructions are further executable by the processor to enable the customer to purchase a price protection product covering at least one of the one or more hedging scenarios.

4. The computer-readable storage medium of claim 1, wherein the program instructions are further executable by the processor to accept a consumption pattern of the commodity associated with the customer and to determine the cost associated with each of the one or more hedging scenarios based on the consumption pattern.

5. The computer-readable storage medium of claim 4, wherein the program instructions are further executable by the processor to accept an adjustment to the consumption pattern.

6. The computer-readable storage medium of claim 1, wherein the program instructions are further executable by the processor to determine a cost associated with purchasing the quantity of the commodity at a retail price.

7. The computer-readable storage medium of claim 1, wherein the program instructions are further executable by the processor to accept a what-if case associated with the commodity and to determine the cost associated with each of the one or more hedging scenarios based on the what-if scenario.

8. The computer-readable storage medium of claim 7, wherein the what-if case pertains to a natural disaster, a war, a political change, a supply disruption, an interest rate change, or a world event.

9. The computer-readable storage medium of claim 1, wherein the program instructions are further executable by the processor to add a non-hedging related cost to the cost associated with each of the one or more hedging scenarios.

10. The computer-readable storage medium of claim 1, wherein the program instructions are further executable by the processor to determine a savings associated with purchasing each of the one or more hedging scenarios and to present the savings to the customer with the one or more hedging scenarios.

11. A method comprising:
creating a risk profile associated with a customer, a commodity, or a combination thereof;
based on the risk profile, creating or selecting one or more hedging scenarios associated with a purchase of a quantity of the commodity;
determining a cost associated with each of the one or more hedging scenarios using a time-based price associated with the commodity; and
presenting the one or more hedging scenarios to the customer via a user interface.

12. The method of claim 11, wherein the time-based price is a historic time-based price.

13. The method of claim 11, further comprising enabling the customer to purchase, through the user interface, a price protection product covering at least one of the one or more hedging scenarios.

14. The method of claim 11, further comprising:
accepting a consumption pattern of the commodity associated with the customer; and
determining the cost associated with each of the one or more hedging scenarios based on the consumption pattern.

15. The method of claim 11, further comprising:
determining a savings associated with purchasing each of the one or more hedging scenarios; and
presenting the savings to the customer with the one or more hedging scenarios.

16. A system comprising:
a processor; and
a computer-readable storage medium accessible by the processor and carrying program instructions executable by the processor to:
create a risk profile associated with a customer, a commodity, or a combination thereof;
based on the risk profile, create one or more hedging scenarios associated with a purchase of a quantity of the commodity;
determine a cost associated with each of the one or more hedging scenarios using a time-based price associated with the commodity; and
present the one or more hedging scenarios to the customer, wherein the customer is an individual user or an entity.

17. The system of claim 16, wherein the time-based price is a historic time-based price.

18. The system of claim 16, wherein the program instructions are further executable by the processor to enable the customer to purchase a price protection product covering at least one of the one or more hedging scenarios.

19. The system of claim 16, wherein the program instructions are further executable by the processor to add a non-hedging related cost to the cost associated with each of the one or more hedging scenarios.

20. The system of claim 16, wherein the program instructions are further executable by the processor to determine a savings associated with purchasing each of the one or more hedging scenarios and to present the savings to the customer with the one or more hedging scenarios.
